(19) United States
(12) Patent Application Publication
(10) Pub. No.: US 2011/0029229 A1
(43) Pub. Date: Feb. 3, 2011

(54) System and Method of Providing Directions to a User of a Wireless Communication Device

(75) Inventor: Yan Hui, Beijing (CN)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/578,626

(22) Filed: Oct. 14, 2009

(30) Foreign Application Priority Data
Jul. 30, 2009 (CN) 200910166974.6

(51) Int. Cl. G01C 21/00

(52) U.S. Cl. 701/201

(57) ABSTRACT

A wireless communication device communicates Radio Frequency (RF) signals with a wireless communication network, and receives navigation signals from a constellation of satellites orbiting the Earth. When the device travels to an area where the RF signals from the network are weak or non-existent, the device automatically activates its Global Positioning Satellite (GPS) receiver, and periodically saves its location to memory. If a user of the device becomes lost, the device can use the saved locations to generate directions to return the user to, or near, the network coverage area.

### RELATED APPLICATION

This application claims the benefit of Chinese Application Number 200910166974.6, filed in China on Jul. 30, 2009. That application, which is entitled “System and Method of Providing Directions to a User of a Wireless Communication Device,” is incorporated herein by reference in its entirety.

### BACKGROUND

The present invention relates generally to communications devices, and particularly to wireless communication devices equipped with satellite navigation receivers.

Wireless communication devices, such as cellular telephones, for example, are common in many areas of the world. A wide array of wireless communication networks supports these devices so that users are able to establish a communication link with one or more remote parties. In most cases, the coverage areas of these networks overlap thereby allowing a user to travel from area to area without losing coverage.

However, there are locations where the signals transmitted by the wireless networks are notably weak and unreliable. In fact, a device may not receive any network signal in some remote locations. For example, dense jungle or mountainous areas may lack a sufficient number of base stations to cover all areas adequately. Even if there are base stations in these areas, the terrain and foliage can cooperate to interfere with or block the signals being communicated with the network. People can quickly become lost in these types of areas, and without a network signal, cannot call someone who might be able to provide them with directions or assistance in finding their way back.

### SUMMARY

The present invention provides a wireless communication device, such as a cellular telephone, for example, that is able to determine when it is not within an area that is covered by a wireless communication network. Upon detecting that the device has left an area of coverage, the device automatically activates a navigation receiver, such as a Global positioning Satellite (GPS) receiver, for example, and calculates the current geographical location for the device for storage in a memory. The device continues to periodically calculate and store its current location in the memory as long as the device remains outside of the coverage area of the network. If the user becomes lost while outside of the coverage area, the device can use the stored locations to generate a set of directions back to an area covered by the network.

Therefore, in one embodiment of the present invention, a wireless communication device comprises a transceiver to communicate Radio Frequency (RE) signals with a wireless communication network, a navigation receiver, such as a GPS receiver, to receive navigation signals from a navigation system, and a controller. The controller is connected to both the transceiver and the navigation receiver, and is programmed to periodically store a current geographical location of the wireless communication device responsive to detecting that the device is not within a coverage area of the network. The controller is also programmed to generate navigation directions based on one or more of the stored locations to return the user to the coverage area of the network.

In one embodiment, the controller is further configured to activate the navigation receiver to calculate the current geographical locations of the device responsive to detecting that the device is not within the coverage area of the network.

In one embodiment, the controller is further configured to deactivate the navigation receiver responsive to detecting that the wireless communication device is within the coverage area of the network.

In one embodiment, the controller is programmed to calculate an initial current location of the device responsive to detecting that a received RF signal strength is below a predetermined level, and then save the initial location as an origination location in memory.

Additionally, the controller is programmed to periodically determine one or more subsequent current locations of the device while the received RF signal strength remains below predetermined level, save the one or more subsequent current locations in memory.

In one embodiment, the device generates the navigation directions by calculating a navigation route from a current location of the device to the origination location.

In some embodiments, the controller is further programmed to alert the user responsive to detecting that the device is not within the coverage area of the network.

In one embodiment, the device also comprises a display. The controller is programmed to calculate a navigation route from a current location of the device to the stored geographical location that is closest to the network coverage area, and display the navigation route on the display.

In addition to a device, the present invention also provides a method of navigating to a predetermined area using a wireless communication device. In one embodiment, the method comprises determining that the wireless communication device is not within a coverage area of a wireless communication network, periodically storing a current geographical location of the device responsive to detecting that the device is not within the coverage area of the wireless communication network, and generating navigation directions based on the stored geographical locations to return the user to the coverage area of the wireless communication network.

In one embodiment, the method further comprises activating a navigation receiver associated with the wireless communication device to determine the current geographic location of the device responsive to detecting that the wireless communication device is not within the coverage area of the network.

Additionally, the method may further comprise de-activating the navigation receiver responsive to detecting that the wireless communication device is within the coverage area of the network.

In one embodiment, the periodically storing a current geographical location of the wireless communication device comprises determining an initial current location of the device responsive to detecting that a received RF signal strength measured at the device is below a predetermined level, and saving the initial current location as an origination location in memory.

In addition, periodically storing a geographical location of the wireless communication device further comprises periodically determining one or more subsequent current locations of the device while the received RF signal strength remains below predetermined level, and saving the one or more subsequent current locations in memory.

In one embodiment, generating the navigation directions comprises calculating a navigation route to the origination location.

In one embodiment, the method comprises alerting the user that the device is not within the coverage area of the network.

In one embodiment, the method further comprises calculating a navigation route from a current location of the device to the stored geographical location that is closest to the network coverage area, and displaying the navigation route on the display of the wireless communication device.

### BRIEF DESCRIPTION OF THE DRAWINGS

FIG. 1 is a block diagram illustrating some of the components of a wireless communication device configured to operate according to one embodiment of the present invention.

FIG. 2 is a perspective view of a wireless communication device suitable for use with one or more embodiments of the present invention.

FIG. 3 illustrates a system suitable for use with a wireless communication device configured according to one embodiment of the present invention.

FIG. 4 is a flow chart illustrating an exemplary method of obtaining location data at a wireless communication device configured to operate according to one embodiment of the present invention.

FIG. 5 is a flow chart illustrating how a device generates and displays directions according to one embodiment of the present invention.

FIG. 6 illustrates some other types of devices that are suitable for use with one or more embodiments of the present invention.

### DETAILED DESCRIPTION

The present invention provides a wireless communication device equipped with a navigation receiver, such as a Global Positional Satellite (GPS) receiver, for example, that helps lost users return to a geographically familiar area. The communication device may be, for example, a cellular telephone that allows a user to communicate with one or more remote parties as long as the user stays within the coverage area of a communication network that services the cellular telephone. If a user travels outside of that network coverage area such that the signals from the network are weak or are lost altogether, the device alerts the user and automatically activates the GPS receiver to obtain the device's current location. That location is saved to memory as an origination location. While the device remains outside of the coverage area of the network, the device periodically determines the current geographical location of the device. Then, if the user is lost, the device can generate directions from the current location to the origination location to assist the user in finding their way back to the coverage area of the network so that the user may establish a communication link.

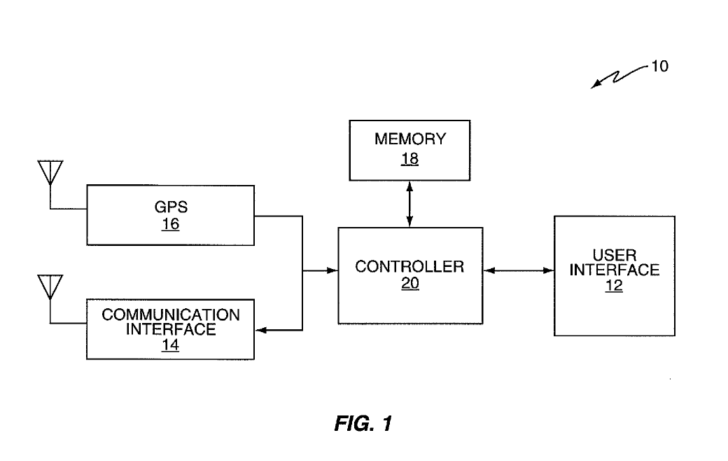

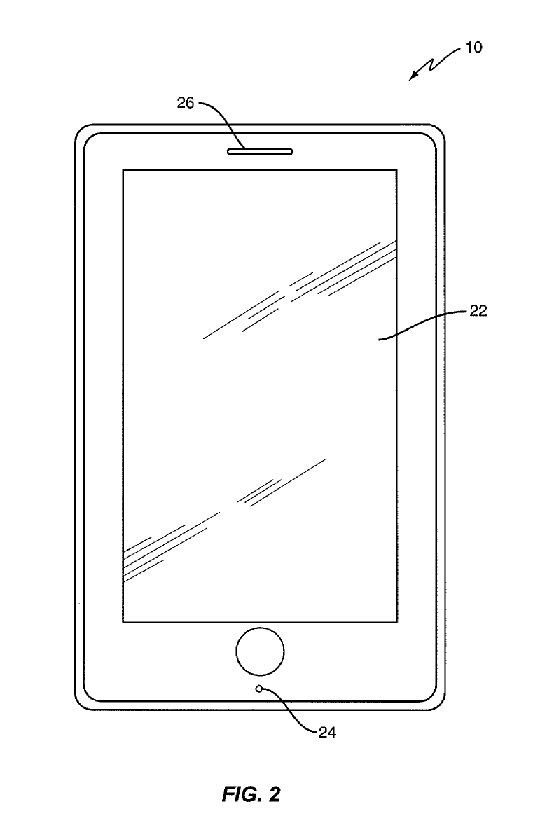

FIG. 1 is a block diagram illustrating some of the components of an exemplary wireless communications device 10 configured according to one embodiment of the present invention. FIG. 2 illustrates a perspective view of device 10. As seen in FIGS. 1 and 2, wireless communications device 10 comprises a user interface 12, a communications interface 14, a Global Positioning Satellite receiver 16, a memory 18, and a controller that is programmed to control each of these components.

The user interface 12 provides a user with the necessary elements to interact with the wireless communications device 10, and typically includes a touch-sensitive display 22, a microphone 24, and a speaker 26 (FIG. 2). The function of each of these components is well known in the art; however, it should be noted that the display 22 may visually render navigation directions generated by the device 10 according to the present invention. Such directions could assist a user of device 10, who may be lost in an area not covered by a network signal, to return to an area where the device 10 enjoys network coverage. The directions may comprise a graphical representation of a route, or text, or a combination of both graphics and text. Additionally, in at least one embodiment, the device 10 is able to render directions to the user as audio via speaker 28 to augment the graphics and/or text on display 22.

The communications interface 14 comprises a transceiver that allows the device 10 to communicate with one or more remote parties via a wireless communication network. In this embodiment, the communications interface 14 comprises a fully functional cellular radio transceiver that can operate according to any known standard, including the standards known generally as the Global System for Mobile Communications (GSM), cdma2000, Universal Mobile Telecommunications System (UMTS), Wideband Code Division Multiple Access (CDMA), 3GPP Long Term Evolution (LTE), and Worldwide Interoperability for Microwave Access (WiMAX). In other embodiments, which are seen in later figures, the communications interface 16 may comprise a hardware port, such as an Ethernet port, for example, that connects device 10 to a packet data communications network. In yet another embodiment, the communication interface 16 may comprise a wireless LAN (802.11x) interface.

The GPS receiver 16 receives navigation signals transmitted from a plurality of GPS satellites in orbit above the Earth, and uses them to calculate its geographical location on the surface of the Earth. The GPS receiver 16 typically includes an RF component as well as the baseband correlation circuitry required for detecting the GPS navigation signals. The method by which the GPS receiver 16 uses the navigation signals received from the satellites to calculate a current geographical position of device 10 is well-known in the art. Therefore, these processes are not described in detail here. However, according to the present invention, GPS receiver 16 may be selectively controlled by controller 20 to obtain its current geographical location depending upon whether the device 10 is or is not within a coverage area of the wireless communication network.

Memory 18 comprises a computer-readable medium that may include both random access memory (RAM) and read-only memory (ROM). Computer program instructions and data required for operation are stored in non-volatile memory, such as EPROM, EEPROM, and/or flash memory, which may be implemented as discrete devices, stacked devices, or integrated with the controller 20. Memory 18 may store one or more locations of the device 10 obtained over time by the GPS receiver 16. According to one embodiment of the present invention, device 10 may use these stored locations to generate directions for a user who may be lost in an area having weak or non-existent network coverage. The directions would help the user navigate from a current location to a location where the device did have adequate network coverage.

Controller 20 generally controls the overall operation of device 10 according to programs and instructions stored in memory 18, and thus, is electrically connected to each of the components 12-18 discussed above. The controller 20, which may be implemented in hardware, firmware, software, or a combination thereof, may comprise a single microprocessor or multiple microprocessors. The microprocessors may be general purpose microprocessors, digital signal processors, or other special purpose processors.

The controller 20 controls the communication interface 14 to transmit and receive Radio frequency (RF) signals with one or more remote parties via a wireless communication network. However, such communications can only occur when the device 10 is within the coverage area of the wireless communication network. When the device travels with the user beyond the boundaries of the coverage area, the device 10 can no longer communicate with the network. Therefore, the controller 20 is programmed to monitor the network conditions and determine whether RF signals received from the network are weak, or are non-existent, because the device 10 has moved beyond the coverage area of the network. Based on that analysis, the controller 20 is programmed to alert the user of device 10, and to automatically activate the GPS receiver 16 to begin periodically obtaining a current location of the device 10. Those locations may be stored in memory 18 and can be used by the controller 20 to generate directions to assist the user in returning to the network coverage area.

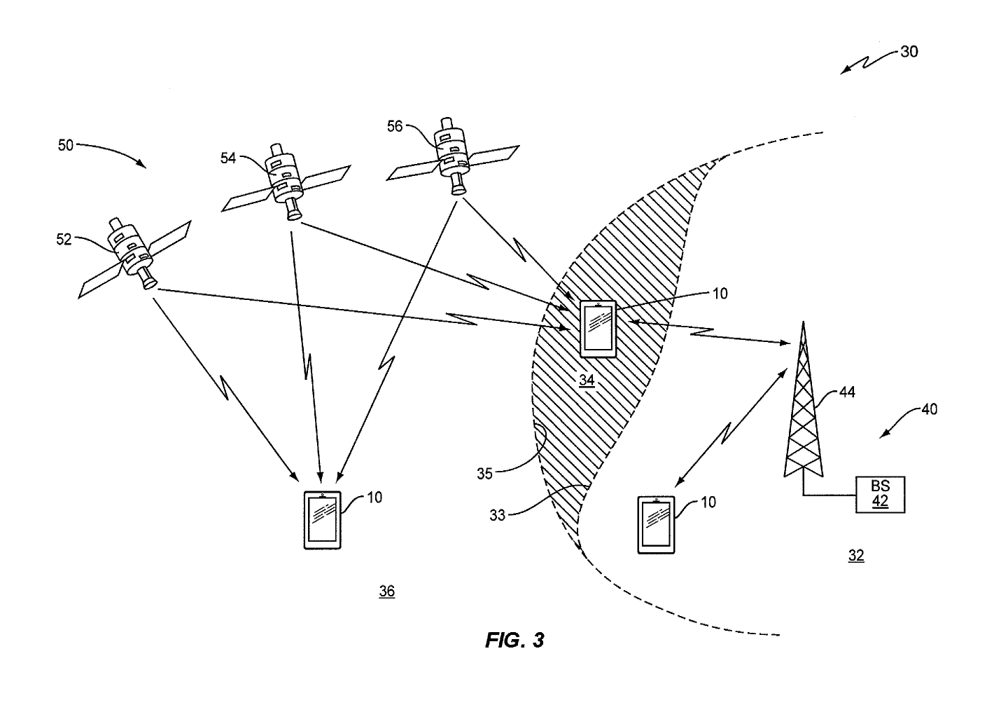

FIG. 3 illustrates system 30 in which a device 10 configured according to one embodiment of the present invention may operate. The system 30 comprises a wireless communication network 40 and a navigational system, which in this embodiment, is a GPS satellite system 50. As is known in the art, the network 40 comprises one or more Base Stations (BS) connected to corresponding antennas 44, which may be fixed-site antenna towers, for example. Network 40 may operate according to any of the aforementioned standards to allow device 10 to establish voice and/or data communications with one or more remote parties, and allow device 10 to access other communication networks, such as the Internet. The satellite system 50 comprises a plurality of satellites 52, 54, 56 in orbit above the Earth's surface. The satellites 52-56 broadcast navigation signals to the surface of the Earth so that suitable receivers, such as the GPS receiver 16 of device 10, can use them to calculate its geographical location on the Earth's surface.

Generally, although only a single base station 42 is shown in FIG. 3, the network 40 will include a plurality of inter-connected base stations 42, each of which provides radio coverage over a cell. In FIG. 3, the area over which the BS 42 provides service to device 10 is cell 32. Cell 32 is relatively free of obstacles such that a device 10 can easily establish and maintain voice and/or data communications with the base station 42 from almost any location in the cell 32. However, some cells will have areas in which obstacles or other problems negatively affect a device's 10 ability to communicate. FIG. 3 illustrates such an area as area 34. In area 34, which is the shaded portion of cell 32, the received signal quality measured at the device 10 is substantially lower than the received signal quality in other parts of the cell 32. Thus, when a device 10 moves over a boundary line 33 into area 34, the user of device 10 may experience degraded communications, or no communications at all. Similarly, there is an area 36 outside of the cell 32 where the base station 42 cannot provide coverage because of its distance from the base station 42. If device 10 were to cross the boundary line 35 into this area 36, which marks the far edge of the base station's 42 coverage area, device 10 will be “out of range” of the base station 42, and thus, not be able to communicate with the network 40.

As previously stated, such a condition may occur in remote countryside areas, or in mountainous areas where the terrain and foliage cooperate to seriously degrade or negate the user's ability to communicate with device 10. In such cases, a user can quickly become lost especially if the user is not familiar with the terrain. While lost, a user without cellular coverage from the base station 42 cannot call for assistance. Therefore, according to the present invention, the device 10 monitors the state of the communications with the base station 42. Upon detecting that the communications have degraded below a predetermined level, the device 10 automatically functions to ensure that the user is able to find his or her way back to an area where the device 10 can communicate with the base station 42.

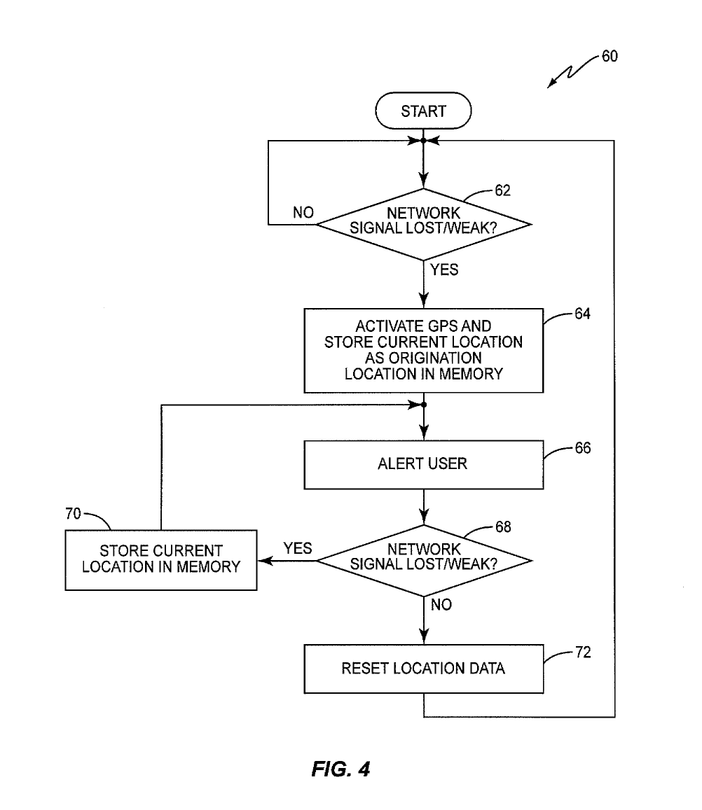

FIG. 4 illustrates an exemplary method 60 by which a device 10 configured according to one embodiment of the present invention assists a user in returning to an area covered by the network 40. Method 60 begins with the device 10 in the area of cell 32. As stated above, the device 10 is able to establish and maintain communications with the base station 42 while in this area. However, if a user crosses boundary line 33 into area 34 where the signals from base station are significantly degraded, or crosses boundary line 35 into area 36 where coverage is non-existent, device 10 may not be able to communicate normally. Therefore, the controller 20 monitors the state of the device 10 as to whether it can communicate with the base station 42 (box 62).

Determining whether the device 10 can communicate with the base station 42 may be accomplished using any method known in the art; however, in at least one embodiment, the controller 20 is programmed to periodically monitor the received RF signal strength at device 10 and compare that value to a predetermined threshold. While in the clear area of cell 32, the received RF signal strength as measured at device 10 will exceed the predetermined threshold. Therefore, the controller 20 would simply continue to monitor the received RF signal strength periodically (box 62). However, when the user crosses the boundary into one of the areas 34 or 36, the received RF signal strength as measured at device 10 will fall below the predetermined threshold. When this occurs, the controller 20 would automatically activate the GPS receiver 16 to obtain a current geographical location for the device 10 and store that location in memory 18 as an “origination” location (box 64). This “origination” location is the location to which the directions generated by the controller 20 will return a lost user.

The controller 20 then generates a control signal to render an alert warning the user that he or she is leaving the network coverage area, and therefore, might lose communications (box 66). While device 10 remains in the areas of inadequate coverage, or no coverage, the controller 20 will continue to monitor the received RF signal strength (box 68). As long as the received RF signal strength remains below the predetermined threshold (e.g., while the user remains in area 34 or 36), the controller 20 will periodically generate control signals to cause the GPS receiver 16 to calculate and store the current geographical location of device 10 (box 70). If device 10 starts once again receiving the RF signals from the network 40 at a level that exceeds the predetermined threshold (box 68), the controller 20 clears the location data saved in memory (box 72) and returns to monitoring the received RF signal strength (box 62).

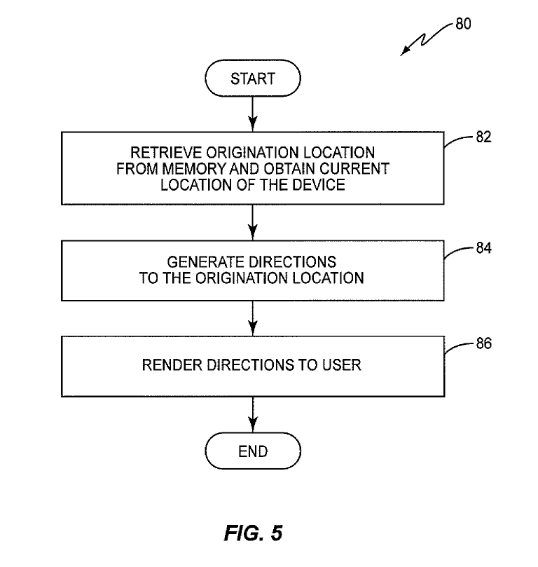

If the user becomes lost in an area that does not have network coverage (e.g., the received signal strength is below the predetermined threshold), the present invention will generate a set of directions based on the current location of device 10 and on the saved “origination” location. Particularly, as seen in method 80 of FIG. 5, the controller 20 retrieves the “origination” location from memory 18, and obtains the current location of the device 10, responsive to receiving a user command such as a menu choice (box 82). The current location may be obtained, for example, by using the GPS receiver 16 to obtain the current location, or by retrieving the last saved location from memory 18. The controller 20 then calculates a set of directions from the current location to the “origination” location (box 84). Once generated, the controller 20 outputs the directions to the display 22 and/or the speaker 24, as previously described (box 86). Following the directions will allow the user to return to an area that is within or near the network coverage area. Once there, the user will be free to establish a call to request assistance, for example.

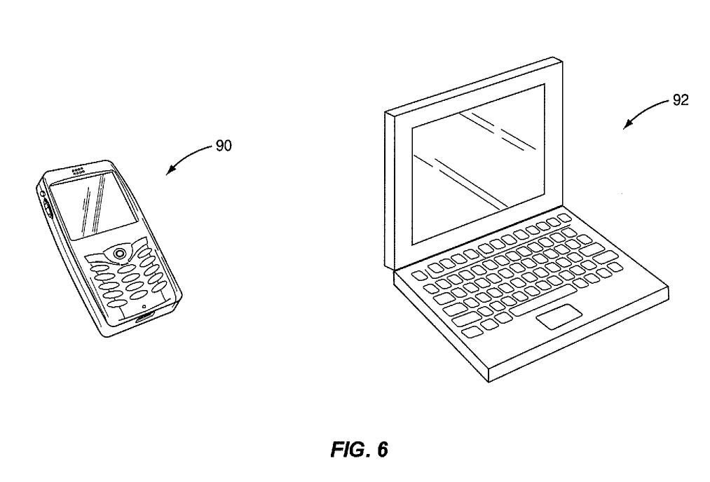

The present invention may, of course, be carried out in other ways than those specifically set forth herein without departing from essential characteristics of the invention. For example, the previous embodiments describe the present invention in terms of device 10 being a cellular telephone. Although device 10 may be a cellular telephone, it is not limited solely to being a cellular telephone. In other embodiments, such as those seen in FIG. 6, the device 10 may be a laptop or notebook computing device 90, or a Personal Digital Assistant (PDA) 92. While not specifically mentioned, other portable communication devices are also suitable for use with the present invention. Therefore, the present embodiments are to be considered in all respects as illustrative and not restrictive, and all changes coming within the meaning and equivalency range of the appended claims are intended to be embraced therein.

What is claimed is:

1. A wireless communication device comprising:
a transceiver configured to communicate Radio Frequency (RF) signals with a wireless communication network;
a navigation receiver configured to receive navigation signals from a navigation system; and
a controller configured to:
periodically store a current geographical location of the wireless communication device responsive to detecting that the device is not within a coverage area of the network;
generate navigation directions based on one or more of the stored locations to return the user to the coverage area of the network.

2. The device of claim 1 wherein the controller is further configured to activate the navigation receiver to calculate the current geographical locations of the device responsive to detecting that the device is not within the coverage area of the network.

3. The device of claim 2 wherein the controller is further configured to deactivate the navigation receiver responsive to detecting that the wireless communication device is within the coverage area of the network.

4. The device of claim 2 wherein the controller is further configured to:
calculate an initial current location of the device responsive to detecting that a received RF signal strength is below a predetermined level; and
save the initial location as an origination location in memory.

5. The device of claim 4 wherein the controller is further configured to:
periodically determine one or more subsequent current locations of the device while the received RF signal strength remains below predetermined level; and
save the one or more subsequent current locations in memory.

6. The device of claim 5 wherein to generate the navigation directions, the controller is configured to calculate a navigation route from a current location of the device to the origination location.

7. The device of claim 1 wherein the controller is further configured to alert the user responsive to detecting that the device is not within the coverage area of the network.

8. The device of claim 1 further comprising a display, and wherein the controller is further configured to:
calculate a navigation route from a current location of the device to the stored geographical location that is closest to the network coverage area; and
display the navigation route on the display.

9. A method of navigating to a predetermined area using a wireless communication device, the method comprising:
determining that the wireless communication device is not within a coverage area of a wireless communication network;
periodically storing a current geographical location of the device responsive to detecting that the device is not within the coverage area of the wireless communication network; and
generating navigation directions based on the stored geographical locations to return the user to the coverage area of the wireless communication network.

10. The method of claim 9 further comprising activating a navigation receiver associated with the wireless communication device to determine the current geographic location of the device responsive to detecting that the wireless communication device is not within the coverage area of the network.

11. The method of claim 10 further comprising de-activating the navigation receiver responsive to detecting that the wireless communication device is within the coverage area of the network.

12. The method of claim 10 wherein periodically storing a current geographical location of the wireless communication device comprises:
determining an initial current location of the device responsive to detecting that a received RF signal strength measured at the device is below a predetermined level; and
saving the initial current location as an origination location in memory.

13. The method of claim 12 wherein periodically storing a geographical location of the wireless communication device further comprises:
periodically determining one or more subsequent current locations of the device while the received RF signal strength remains below predetermined level; and
saving the one or more subsequent current locations in memory.

14. The method of claim 13 wherein generating the navigation directions comprises calculating a navigation route to the origination location.

15. The method of claim 9 further comprising alerting the user that the device is not within the coverage area of the network.

16. The method of claim 9 further comprising:
calculating a navigation route from a current location of the device to the stored geographical location that is closest to the network coverage area; and
displaying the navigation route on the display of the wireless communication device.
